(19) United States
(12) Patent Application Publication
(10) Pub. No.: US 2016/0074902 A1
(43) Pub. Date: Mar. 17, 2016

(54) Device and Method for Applying Nanoparticle Surface Treatments

(71) Applicants: John Miller, Eugene, OR (US); Richard Geiger, Eugene, OR (US)

(72) Inventors: John Miller, Eugene, OR (US); Richard Geiger, Eugene, OR (US)

(21) Appl. No.: 14/488,284

(22) Filed: Sep. 17, 2014

(51) Int. Cl. B05D 1/02; B05B 1/00; B05D 1/18

(52) U.S. Cl. CPC B05D 1/02; B05D 1/18; B05B 1/00

(57) ABSTRACT

An apparatus for applying a surface coating to a substrate comprised of a housing, a means for delivering a surface coating to the substrate and a means for providing an external stimulation to catalyze the bonding of the surface coating to the substrate. Additionally, disclosed is a method of applying a surface coating to a substrate by concurrently providing a surface coating and a source of stimulation that is suitable for bonding the surface coating to the substrate.

### CROSS-REFERENCE TO RELATED APPLICATIONS

This application claims the benefit of U.S. Provisional Application No. 61/879,141 filed Sep. 17, 2013 titled “Device to apply nanoparticle surface treatments”

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention is in the field of nanoparticle coating applicators and aspects of the invention pertain particularly to methods and apparatuses for applying nanoparticle coatings to textiles.

2. Summary of the Prior Art

In U.S. Pat. No. 8,512,417, a chemical process is taught that links or bonds and nanoparticles to surfaces. In that patent, an external stimulus is used to encourage/activate a linker. That patent does not describe how the external stimulus is to be applied or even what the stimulus is.

U.S. Pat. No. 7,811,627 B2 entitled Papermaking Fabrics with Contaminant Resistant Nanoparticle Coating and Method of in situ Application, discloses the application and selective stimulation of nanoparticle coatings. Particularly, the patent discloses a nanoparticle type coating that is applied to an industrial textile and then cured in a separate operation with the use of heat. However this patent does not disclose a handheld applicator suitable for non-commercial use.

U.S. Pat. No. 7,141,518 B2 entitled Durable Charged Particle Coatings and Materials discloses the binding of high surface area materials to substrates. This patent discloses a fabric being exposed to ultrasonic energy while within a bath of aqueous high surface area material, the ultrasonic energy used to promote bonding. However, this patent does not disclose a handheld applicator or method of use suitable for selective coating of a textile.

U.S. Pat. No. 7,112,621 B2 entitled Coating Compositions for Modifying Surfaces discloses methods and articles of manufacture comprising a nanoparticle system for imparting surface modifying benefits for all types of soft surfaces. The patent discloses coating compositions applied by hand or a machine. Particularly, distribution of the coating composition can be achieved by using a wide variety of application methods and devices, including but not limited to: spray devices, immersion containers, printers, washing machines, spray hose attachments, rollers and pads. However, the patent does not disclose an apparatus or method employing a combined application and stimulation of the coating.

It is apparent that there is a need for a method for efficiently applying functionalized coatings to textiles fabrics wherein the application and stimulation steps are combined. Further there is a need for apparatuses that enable the performing of such a method wherein a functionalized coating is applied and activated in a single pass by the apparatus.

### SUMMARY OF THE INVENTION

The present invention is generally directed to apparatuses and methods suitable for producing an antimicrobial substrate. One aspect of the invention is an apparatus for applying a surface coating to a substrate wherein the apparatus has a housing with a handle, a means for delivering a surface coating and a means for providing an external stimulation to the surface of the substrate. The apparatus is suitable for the handheld application of surface coatings with antimicrobial properties to a target substrate.

Another aspect of the invention is device for applying antimicrobial surface coatings to a substrate in a mass production setting via the use of a mandrel with a plurality of holes that are fluidly connected to an external stimulation inlet. During operation, a target surface is stretched or located over the mandrel. When a surface coating is then applied to the substrate and an external stimulation is provided at the external stimulation inlet, the surface coating binds to the suprate only in the locations where the external stimulus contacts the target surface via the plurality of holes. This approach allows for the selective coating of target surfaces, such as applying an antimicrobial coating in the armpit area of a shirt, or applying a reflective coating in visible areas on safety clothing for a cyclist.

In accordance with the invention, also disclosed is a method for applying surface coatings to a substrate comprising providing an apparatus for delivering a surface coating that is reactive with a stimulation, and a source of said stimulation. The surface coating and the stimulation are delivered to the substrate concurrently thus catalyzing the bonding of the surface coating to the substrate. As a result the apparatus may be moved back and forth over the target surface while applying and bonding a surface coating to a target. Such a method is suitable for the handheld application of surface coatings to target substrates.

### BRIEF DESCRIPTION OF THE DRAWINGS

FIG. 1 depicts a handheld applicator constructed according to aspects of the invention.

FIG. 2 depicts handheld applicator depicted in FIG. 1 in operation.

FIG. 3 depicts another embodiment of an applicator constructed according to aspects of the invention.

FIG. 4 depicts a linear arrangement of coating and stimulation streams as envisioned in one embodiment of the invention.

FIG. 5 depicts a concentric arrangement of coating and stimulation streams as envisioned in one embodiment of the invention.

FIG. 6 depicts an embodiment of the invention adapted for mass production.

### DETAILED DESCRIPTION OF THE INVENTION

At the outset, it should be appreciated that while the present invention is described with respect to what is presently considered to be the preferred embodiments, it is to be understood that the invention is not limited to the disclosed embodiments.

For the purposes of this disclosure, antimicrobial is understood to refer to the property of being capable of destroying or suppressing the growth of harmful microorganisms whether bacteria, viruses, or fungi, on inanimate objects and surfaces. Additionally, nanoparticles are defined as discreet particles either suspended or dissolved in solution or dry powder, with one or more dimension on the 1 nm to 100 nm scale range. The definition of nanoparticles includes materials with nano-sized dimensions that are spheroidal, tubes, rod-shaped, wires, cubic, aggregates, nanotubes, among others.

Aspects of the invention are directed toward novel means and methods of supplying an external stimulus to catalyze and/or activate a reaction that will permanently bond or link sub-micron particles or nanoparticles to surfaces to impart new properties to those surfaces. In the preferred embodiment, a cross-linking agent and nanoparticles are sprayed, rolled, dip coated or otherwise deposited onto the target surface before one or more external stimuli is concurrently applied to catalyze/activate the linker to bind the particles to the surface. Also in the preferred embodiment, the external stimulus is heat, applied as steam exiting from a handheld applicator 1 or nozzle, stationary nozzle or otherwise portable device. In one such embodiments, a handheld applicator 1 directs the steam onto the target surface as the handheld applicator 1 is held near, or in direct contact with the target surface. Preheat or steam can be applied to the target surface prior to deposition of the active ingredient.

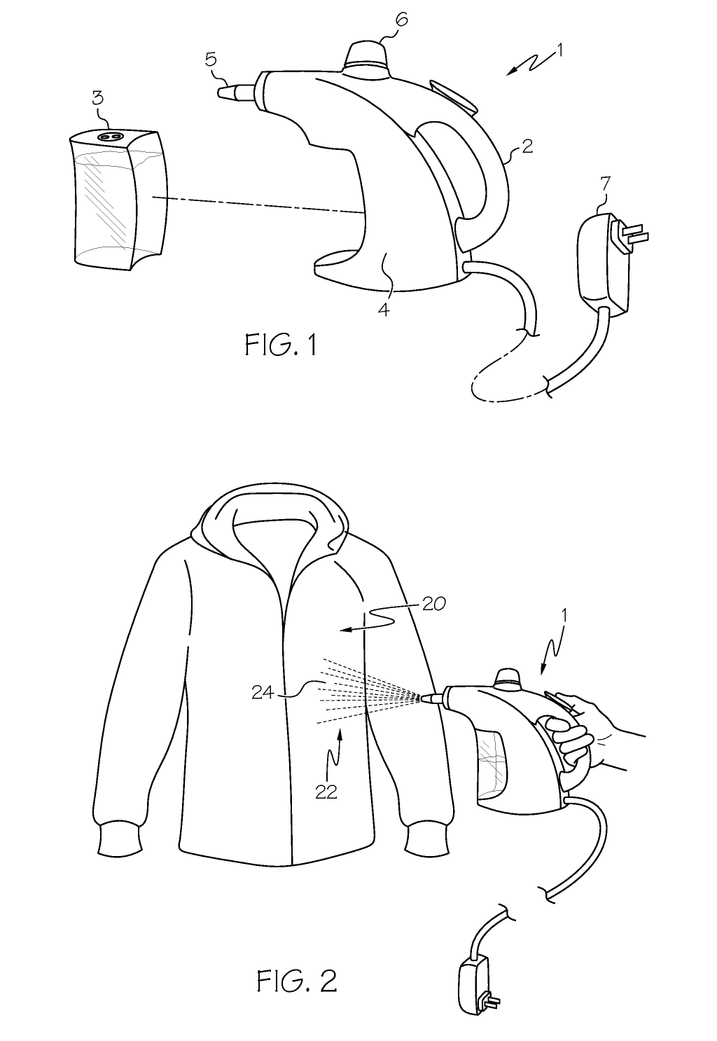

FIG. 1 discloses an embodiment of a handheld applicator 1. The handheld applicator 1 is comprised of a housing 4, a handle 2, a liquid containing cartridge 3, at least one nozzle 5, a refillable water reservoir 6, and a power source 7. This configuration is exemplary. Other configurations may have more or less features. Additionally, in certain embodiments, the housing 4 and handle 2 may be one and the same, such as in the case of a spray bottle which is held by the housing. In operation, the handheld applicator 1 supplies both an external stimulus and a coating agent which is catalyzed/activated by the external stimulus.

Referring to the liquid containing cartridge 3 in more detail, in the preferred embodiment, the liquid contained is the cartridge 3 contains both a linker and a nanoparticle. The linker and nanoparticle may be initially contained in one or more sealed cartridges 3. In an embodiment using sealed cartridges 3, the cartridges 3 are breached when they are installed into the handheld applicator 1 housing 4. The use of sealed cartridges 3 prevents the user from coming into contact with the liquid inside the cartridges 3. In alternative embodiments, the cartridges 3 can be manually opened and a coating agent may be poured into the cartridge 3 by the user. In still further embodiments, the cartridge 3 may be constructed as part of the housing 4 wherein the user may manually fill the cartridge 3 via an access port in the housing 4.

Referring to the liquid contained in the cartridge 3 in more detail, in the preferred embodiment, the liquid is comprised of a cross-linking agent and a nanoparticle. The cross-linking agent can be the linker material described in patent U.S. Pat. No. 8,512,417 B2. In other embodiments it can be one of numerous cross-linking agents that bond to substrates using one or more stimuli including thermal, optical (UV/VIS, RF) electromagnetic, and chemical promoters among others. Examples of cross-linking agents include peroxides, epoxides, silanes, siloxanes, silicones, urethanes, acrylates, azides, triazenes, diazirines, imides, and polyimides among others. Chemical stimuli that can promote/catalyze these cross-linking reactions include homogeneous and heterogeneous catalysts, acids and bases to control pH, salts, radical initiators, and enzymes among others.

Referring to the liquid contained in the cartridge 3 in more detail, in alternative embodiments the liquid is not comprised of a cross-linking agent. In such embodiments the liquid may contain nanoparticles that are able to bind to a textile fiber without the use of the cross-linking agent. In such embodiments the nanoparticles have a chemical functionality that is reactive with a target surface and/or the application of the stimuli induces the particles to bind a target surface. Such as would occur by using an acid or base to precipitate the nanoparticles.

In the preferred embodiment, the nanoparticles are silver nanoparticles. The preferred application uses the silver nanoparticles as an antimicrobial treatment. The silver nanoparticles can be applied for other purposes including electronic, antistatic or shielding. In other embodiments, sub-micron and nano-sized materials of metals, metal oxides, polymers, semiconductors, biomolecules, or composites thereof, with and without stabilizers, can be used to impart a variety of properties to treated surfaces including air cleaning, antistatic, antibacterial, antifungal, pesticidal, reflective, hydrophobic, hydrophilic, flame-retardant/heat resistant, UV-blocking, scent-releasing, odor-absorbing, abrasion-resistant, color-brightening, and authentication among others. Examples of other suitable metals include, the Cu, Zn, Ti, Zr, Sn or other active chemical groups including quaternary amines, phosphates, and iodates. The sub-micron particles and nanoparticles can be in the form of spheres, rods, tubes, prisms, platelets, fibers, or irregular geometries as a dry powder, slurry, dissolved solution, or in other dispersed media. Additional embodiments include combinations of one or more nanoparticle to impart multiple properties to the treated surface. For example, hydrophobic nanoparticles could be mixed with silver nanoparticles to impart hydrophobicity and antimicrobial action.

Referring to the handheld applicator 1 in more detail, in the preferred embodiment, the linker and nanoparticles are sprayed or otherwise deposited onto the target surface when a trigger or button located in or on the housing 4 is activated. Also, the dispensing of the linker and nanoparticles can be tied to the motion of the handheld applicator 1. The motion can be detected using accelerometers, gyros, or CCD/optical mouse type sensors, or wheeled mouse type sensors. The linker and nanoparticles can then be metered proportional to movement or in response to movement of the handheld applicator 1 in an attempt to prevent overexposure to a targeted area

In the preferred embodiment, heat is the means of external stimulus which is supplied by a stream of steam that exits the handheld applicator 1 via a nozzle 5. In other embodiments the heat can be applied in the form of hot dry air, or can be heat transferred from a heating element in the device by the device physically touching or being placed near a hot surface, such as an iron. In still further embodiments, the external stimulus can be UV light produced by a florescent lamp, an LED, a gas discharge lamp, or a laser, suitable for to activating a UV-activated linker, or RF or other EM radiation produced by an electromagnet or other source to inductively heat nanoparticles, or sonic energy from transducers or any combination of these external stimuli thereof.

In the preferred embodiment, the water for the steam can be stored within the handheld applicator 1 in a refillable water reservoir 6 or in a portable car 32 or stationary base that is connected to the handheld applicator 1 by a hose. The force that propels the steam out of the nozzle 5 in a stream can be generated by the action of heating the water or via a pump, fan or any other means suitable for propelling the steam in a stream from the handheld applicator 1.

FIG. 2 depicts the handheld applicator 1 in operation. In operation, the handheld applicator 1 supplies a stream of steam 22 and a steam of coating agent 24 to a target surface 20. A user can move the streams of steam 22 and stream of coating agent 24 across the entire surface of the target surface 20 to coat the entire target surface 20, or apply the stream to only the areas of the target surface 20 where the resultant effects of the coating agent are desired.

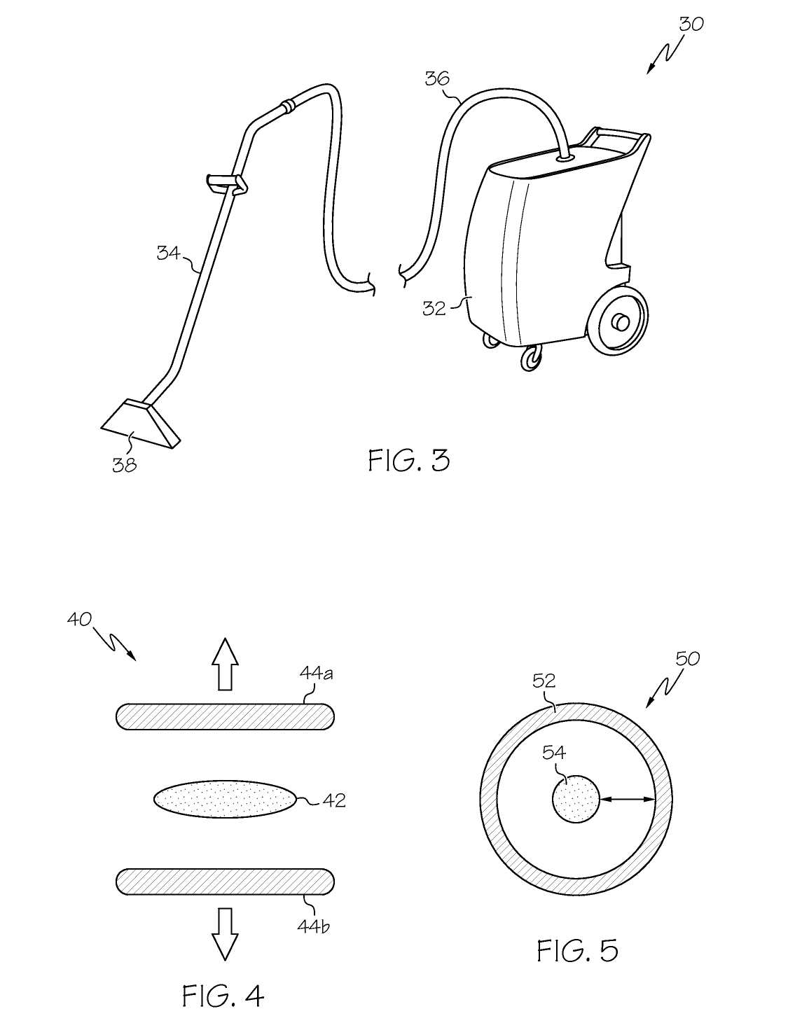

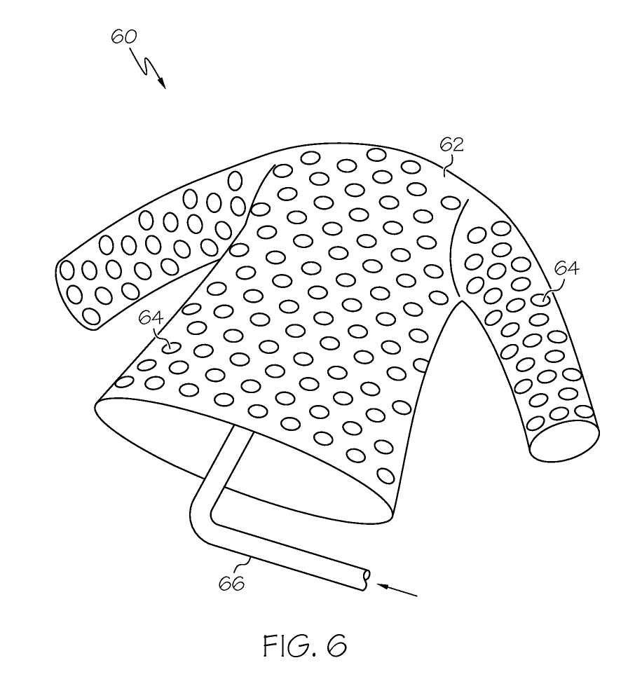

Although in the preferred embodiment, the linker, nanoparticles and heat are applied via a handheld applicator 1, another embodiment is depicted in FIG. 3. FIG. 3 depicts a rolling floor device 30 embodiment comprised of a handheld wand 34, a portable cart 32 and a tube 36 connecting the handheld wand 34 to the portable cart 32. The rolling floor device 30 further may comprise a rectangular nozzle 38 suitable for a configuration such as the configuration depicted in FIG. 4. The rectangular nozzle 38 configuration will enable a user to coat a target surface by moving the handheld wand 34 forward and back over a target surface.

In one configuration of the nozzle 5 as envisioned by the invention, each of the plurality of nozzles 5 is shaped like a long rectangle. In the configuration depicted in FIG. 4 there are three long parallel streams, two comprised of streams of an external stimulus 44a, 44b and one of a central coating agent stream 42. Alternatively, each of the long parallel streams 44a, 44b, 42 can be made from a plurality of smaller holes in line. The central coating agent stream 42 supplies the linker and nanoparticles to the target surface and the outer streams supply the external stimulus, preferably activating heat. In a handheld applicator 1 utilizing this type of nozzle 5 pattern, the handheld applicator is operated by moving the streams primarily normal to the long axis of the streams.

In the embodiment depicted in FIG. 1, the external stimulus is supplied concurrently with the coating agent, so that when the stream is moved laterally in any direction, the area of the target surface 20 which is contacted by the coating agent is then contacted by the external stimulus. A configuration of the external stimulation stream 52 and coating agent stream 54 is depicted in FIG. 5. In the circular configuration 50 heat or other stimuli is projected around the outside of a central coating agent stream 54. The central coating agent stream 54 contains a mixture of the linker and nanoparticles from the cartridge 3. As a result, when the combination of streams 52, 54 are moved in any direction the linker and nanoparticles are deposited first and then the external stimulus contacts the area where the linker and nanoparticles where just applied. The central coating agent stream 54 can be round or elliptical/oval in shape and the surrounding external stimulus streams 52 can be round or elliptical/oval in shape. The surrounding external stimulus stream 52 can be a plurality of discrete streams made by passing the external stimulus through a plurality of holes or nozzles in a circular, elliptical or oval shape (as shown), or a single stream by passing the heat through one single slot.

Applications for the preferred embodiment are broad and depend on the properties of the surface treatment comprised of linker and nanoparticles. One application is to apply antimicrobial surface treatments to textiles which can include sports apparel, undergarments, hosiery, shoes, socks, pet products, hats, bags, purses, wallets, packs and beds. In addition, carpet, upholstery, draperies and rugs can be treated. Providing antimicrobial treatments to hospital carpeting and upholstery, automotive carpeting and upholstery along with airplane cabin carpeting and upholstery are targets of this invention. Also, rigid products like helmets, shoulder pads, shin guards and other sporting goods can be treated easily at the point of use. In addition to textiles, grout and other hard surfaces can be treated using the device described herein. Additional applications include those in which there is a desire for air cleaning, antistatic, antibacterial, antifungal, pesticidal, reflective, hydrophobic, hydrophilic, flame-retardant/heat resistant, UV-blocking, scent-releasing, odor absorbing, abrasion-resistant, color-brightening, authentication or other properties.

In another embodiment, these materials can be applied by a motor controlled applicator in a controlled fashion, similar to an ink jet printer. In such an embodiment, a linker, a nanoparticle and an external stimulus can be applied via one or a plurality of motor controlled applicators which may be selectively positioned relative to a target surface. Each motor controlled applicator can control the location for each application of the linker, nanoparticle and external stimulus. The linker, the nanoparticles and the external stimulus may be supplied by the same applicator or via separate applicators, which may be controlled and or translated independently from one another. In such an embodiment a control system is employed to activate a motor controlled applicator to selectively dispense nanoparticles on a target surface. Then the control system is employed to activate a motor controlled applicator to selectively dispense a linker on the target surface. Lastly, control system is employed to activate a motor controlled applicator to selectively expose the target surface to an external stimulus. In alternative embodiments, the nanoparticle dispensing and linker dispensing step may take place in the same step and as a result of activating a single motor controlled applicator. Further, it should be understood that this embodiment is suitable for use with any of the target surfaces, linkers, nanoparticles, or external stimulus as described elsewhere in this disclosure.

In some situations it is desirable for the invention to utilize a form factor that is better suited to mass production techniques. Such an embodiment of the invention is an apparatus 60 adapted for facilitating the rapid processing and coating of textiles or other surfaces. This apparatus 60 is comprised of a mandrel 62 with a plurality of holes 64. A target surface can be draped or stretched over the mandrel 62. The target surface is then properly located for applying a linker and nanoparticle solution which can be sprayed, dip coated or roll coated onto the target surface while it is located on the mandrel 62. The plurality of holes 64 located on the mandrel 62 are fluidly connected with an external stimulus inlet 66. In operations, an external stimulus is provided to the external stimulus inlet 66. The external stimulus may be any of the external stimuli discussed elsewhere in this disclosure. Preferably though, the external stimulus is steam or hot air. The steam or hot air enters the external stimulus inlet 66 and exits the mandrels via the plurality of holes 64. In operation, the linker and nanoparticle are selectively bonded to the target surface only where the external stimulus contacts the target surface. In an embodiment of the apparatus 60 that uses steam or hot air, the mandrel 62 remains cool and forms a mask that prevents the activation of the linker and nonparticle other than in the areas located over the plurality of holes 64. Thus, the apparatus allows for the selective application of a nanoparticle coating to target surfaces in repeatable method suitable for mass production techniques.

Referring to the mandrel 62 in more detail, the mandrel may take the shape of a mannequin, a cylinder, a human torso or any other 2 or 3 dimensional surface as would be required in a particular application. Further, the plurality of holes 64 may be located in a variety of ways. The plurality of holes 64 may be located over the entire surface of the mandrel 62, as shown. Alternatively, the plurality of holes 64 may be located in specific areas or with a specific pattern so as to impart a pattern of coated areas on the target surface. An example of this would include aligning the plurality of holes 64 on a torso shaped mandrel 62 to selectively coat a shirt pulled over the mandrel 64 with an antimicrobial coating only in the underarm area.

Furthermore, it should be understood that aspects of the invention are not limited to the particular methodology, materials and modifications described above and as such may vary. It is also understood that the terminology used herein is for the purpose of describing particular aspects only, and is not intended to limit the scope of the present invention.

Thus, specific apparatuses and methods relating to devices and method for applying nanoparticle surface treatments have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

The invention claimed is:

1. An apparatus for applying a surface coating to a substrate comprising
a housing with a handle; and
a means for delivering a surface coating to the substrate; and
a means for providing an external stimulation to catalyze the bonding of the surface coating to the substrate.

2. The invention of claim 1 wherein the surface coating includes an antimicrobial agent.

3. The invention of claim 2 wherein the antimicrobial agent is selected from a group consisting of a metal, a metal salt, a metal oxide, a metal ion containing polymer, a metal ion containing ceramic, or a quarternary ammonium silane and a metal complex.

4. The invention of claim 3, wherein the antimicrobial agent is a particle with smallest dimension in the range of 1 nm to 1 um.

5. The invention of claim 2 wherein the antimicrobial agent is reactive to chemical cross-linking agents selected from a group consisting of acids, bases, peroxides, epoxides, silanes, siloxanes, silicones, urethanes, acrylates, azides, triazenes, diazirines, imides, polyimides, and agents that precipitate nanoparticles on the substrate.

6. The invention of claim 1, wherein the surface coating is a particle with a smallest dimension in the range of 1 nm to 1 um.

7. The invention of claim 6 wherein the particle is selected from a group consisting of a metal, a metal salt, a metal oxide, a polymer, a dendrimer, a ceramic, carbonaceuous material such as carbon nanotubes, spheres, and wires, and a composite.

8. The invention of claim 7 wherein the particle is reactive with a chemical cross-linking agent selected from a group consisting of peroxides, epoxides, silanes, siloxanes, silicones, urethanes, acrylates, azides, triazenes, diazirines, imides, and polyimides and agents that precipitate nanoparticles on the substrate.

9. The apparatus of claim 1 wherein the means for providing the external stimulation to catalyze the bonding of the antimicrobial agent to the substrate is at least one of hot air source, a steam source, an electromagnet and a chemical catalyst.

10. The device of claim 1, wherein the housing is a wand attached to a stationary apparatus containing a water reservoir.

11. A device for applying antimicrobial surface coatings to substrates comprising
a mandrel wherein the mandrel contains a plurality of holes wherein the
plurality of holes are fluidly connected to an external stimulation inlet; and
a means of delivery of an antimicrobial formulation to a substrate; and
a means for providing an external stimulation at the external stimulation inlet

12. The invention of claim 11 wherein the antimicrobial formulation includes an antimicrobial agent.

13. The invention of claim 12 wherein the antimicrobial agent is selected from a group consisting of a metal, a metal salt, a metal oxide, a metal ion containing polymer, a metal ion containing ceramic, and a quarternary ammonium silane.

14. The invention of claim 13, wherein the antimicrobial agent is a particle with a smallest dimension in the range of 1 nm to 1 um.

15. The invention of claim 14 wherein the antimicrobial agent is reactive with at least one chemical cross-linking agent selected from the group consisting of peroxides, epoxides, silanes, siloxanes, silicones, urethanes, acrylates, azides, triazenes, diazirines, imides, and polyimides and agents that precipitate nanoparticles on the substrate.

16. The device of claim 11 wherein the means for providing the external stimulation is one of a hot air source, a steam source and a chemical agent.

17. A method for applying a surface coatings to a substrate comprising
providing an apparatus for delivering a surface coating, and a source of stimulation; and
delivering the surface coating to the substrate and concurrently stimulating said substrate such that when the apparatus is tanslocated relative to the substrate the stimulation catalyzes the bonding of the surface coating to the substrate.

18. The invention of claim 17 wherein the surface coating include one or more particles of metal, metal oxides and other ceramics, polymer or macromolecules, or carbon nanoparticles

19. The invention of claim 18, wherein the particles are particles that have one or more dimensions in the size range of 1 nm to 1 um.

20. The invention of claim 19 wherein the nanoparticles are dissolved, suspended, or otherwise dispersed in a liquid medium including aqueous and organic solvents.

21. The invention of claim 20 wherein the nanoparticles have one or more functional groups selected from the group consisting of peroxides, epoxides, silanes, siloxanes, silicones, urethanes, acrylates, azides, triazenes, diazirines, imides and polyimides.

22. The invention of claim 21 wherein the nanoparticle formulation includes nanoparticles and a cross-linking agent selected from the group consisting of peroxides, epoxides, silanes, siloxanes, silicones, urethanes, acrylates, azides, triazenes, diazirines, imides, and polyimides.
